(19) United States
(12) Patent Application Publication
(10) Pub. No.: US 2022/0026229 A1
(43) Pub. Date: Jan. 27, 2022

(54) ROUTE LOCATION MONITORING SYSTEM

(71) Applicant: Westinghouse Air Brake Technologies Corporation, Pittsburgh, PA (US)

(72) Inventor: Matthew Vrba, Marion, IA (US)

(21) Appl. No.: 17/386,041

(22) Filed: Jul. 27, 2021

Related U.S. Application Data
(60) Provisional application No. 63/056,846, filed on Jul. 27, 2020.

(51) Int. Cl. G01C 21/36; G06T 7/73; G01C 21/34; G06F 16/29

(52) U.S. Cl. CPC G01C 21/3602; G06T 7/74; G06T 2207/30256; G01C 21/3407; G06F 16/29; G01C 21/3691

(57) ABSTRACT

A method is provided that may include obtaining image data related to a route from a imaging device associated with a vehicle, determining a geometric pattern related to the route based on the image data, and identifying the geometric pattern determined within a route database to determine the route of the vehicle.

### CROSS-REFERENCE TO RELATED APPLICATIONS

This application claim priority to U.S. Provisional Application No. 63/056,846 entitled Route Location Monitoring System filed Jul. 27, 2020, hereby incorporated by reference herein.

### BACKGROUND

### Technical Field

The subject matter described relates to a monitoring system for a vehicle.

### Discussion of Art

Vehicle monitoring systems may be used to determine the location of a vehicle. Often, offboard devices such as global navigation satellites, including global positioning systems (GPS), are used to determine the location of a vehicle. The GPS may be part of a navigation system of the vehicle or a standalone device that may be placed in the vehicle.

For some vehicles, navigation satellite systems can be insufficient to locate the vehicle. For example, rail vehicles may have numerous individual cars that combine to form a vehicle system. Because of the multiple vehicles, detail must be considered regarding where the front vehicle is located in relation to the back vehicle. In addition, vehicles often travel through tunnels, in and out of buildings, in remote locations, in urban locations having tall buildings, in mountainous regions, etc., all of which can result in spotty coverage and difficulties in determining vehicle location. Additionally, often multiple routes can exist in one location, such as in a depot, switch, on a multi-lane route, etc., causing difficulties for location devices to locate the exact route that a vehicle is using.

A positive vehicle control system is a monitoring system that monitors the locations of numerous vehicles in a network of routes to communicate with the vehicles to prevent collisions or other unsafe traveling conditions. The positive vehicle control systems operate by determining which segments of routes are occupied by vehicles, are undergoing maintenance, or the like. When the location of a vehicle is incorrect, such systems make determinations on incorrect information, potentially leading to unsafe traveling conditions.

### BRIEF DESCRIPTION

In one or more embodiments, a method is provided that may include obtaining image data from an imaging device onboard a vehicle, determining a geometric pattern from the image data, and identifying which route the vehicle is located on by determining whether the geometric pattern appears within a route database.

In one or more embodiments, a system is provided that may include a monitoring system including at least one imaging device onboard a vehicle that is configured to be disposed within a vehicle and positioned to capture image data related to a route of the vehicle. The system may also include one or more processors that are configured to obtain the image data related to the route from the at least one imaging device, determine a geometric pattern from the image data, and identify which route the vehicle is located on by determining whether the geometric pattern appears within a route database.

In one or more embodiments, a system is provided that may include a monitoring system with at least one imaging device that is configured to be disposed within a vehicle and positioned to capture image data. The system also may include one or more processors configured to obtain the image data from the at least one imaging device, and determine a geometric pattern related to the route from the image data. The one or more processors may also be configured to obtain positioning data from an offboard device, select a route database based on the positioning data, and match the geometric pattern determined to a geometric pattern of a route image within the route database selected to determine the route of the vehicle.

### BRIEF DESCRIPTION OF THE DRAWINGS

The inventive subject matter may be understood from reading the following description of non-limiting embodiments, with reference to the attached drawings, wherein below:

FIG. 1 illustrates a schematic diagram of a vehicle system;

FIG. 2 illustrates a schematic diagram of a monitoring system;

FIG. 3 illustrates a method for determining a location of a vehicle on a route;

FIG. 4 illustrates a method for displaying a route location of a vehicle;

FIG. 5 illustrates a method of determining the location of a vehicle;

FIG. 6A illustrates one example of a geometric shape of a route;

FIG. 6B illustrates another example of a geometric shape of a route;

FIG. 6C illustrates another example of a geometric shape of a route;

FIG. 7A illustrates another example of a geometric shape of a route; and

FIG. 7B illustrates another example of a geometric shape of a route.

### DETAILED DESCRIPTION

Embodiments of the subject matter described herein relate to a monitoring system that obtains image data of one or more routes, determines one or more geometric patterns from the image data, and identifies which route a vehicle is on by comparing the geometric pattern(s) with different geometric patterns associated with different routes. The geometric pattern may include or be based on the presence of features in the image data (e.g., surfaces, lines, shapes, etc.), the spacing between the features in the image data, or the like. The geometric pattern can be compared to several different patterns stored in a route database. The images within the route database may be obtained based on an offboard device (e.g. global navigation satellite system) information or other positional information. In this manner, the offboard device information may only be used to determine a coarse location of the vehicle or a coarse determination of one or several routes that the vehicle may be located on. Based on this coarse determination, patterns of routes in the general vicinity of the initial location are compared against the image obtained with the geometric pattern. By matching the geometric pattern of the image obtained to a geometric pattern of a route in the route database, the location of the vehicle can be determined. For additional verification, the number of routes counted also may be utilized. The vehicle location can be communicated to a positive vehicle control (PVC) system.

The monitoring system may include a forward-facing imaging device installed on a vehicle that is connected to the PVC system that may also be installed in the vehicle. The image may include a timestamp of when the image was taken. The PVC system processes the received image and determines a geometric pattern from the detected routes and related components such as switches, switch routes, and other environmental-based landmarks. The monitoring system also estimates distances between lines in the geometric pattern by using image processing techniques to determine the distance between objects in the image. Imagining techniques may include pixel count in relation to a known object size. The monitoring system may also use geographic location input from another system (e.g., an offboard device such as a global navigation satellite system) to determine an estimated geographic location of the vehicle. When using the global navigation satellite system, the PVC system either determines a route database, or searches a route database for routes within a geographic radius of the global navigation satellite system-determined location. The PVC system may then match the geometric pattern between the image data and the route database data, including matching distances between objects. If a match is identified, the number of routes on either side of the route (e.g., to the left and/or right of the route) also may be counted to verify the matched geometric pattern. In addition, the identifier of the route may similarly be determined. Based on the known route identifier, number of tracks, geometric pattern, etc., the PVC system may determine a more precise location of the vehicle to be used by the PVC system functions that depend on vehicle location. This location may be more precise than the satellite-determined location. For example, the more precise location may have a smaller potential error than the satellite-determined location.

A PVC system is a monitoring system utilized by a vehicle system to allow the vehicle system to move within a designated restricted manner (such as above a designated penalty speed limit, to enter another route segment, etc.) only responsive to receipt or continued receipt of one or more signals (e.g., received from off-board the vehicle) that meet designated criteria, e.g., the signals have designated characteristics (e.g., a designated waveform and/or content), are received at designated times (or according to other designated time criteria), and/or under designated conditions. For example, the vehicle may be automatically prevented from entering into another route segment unless a signal is received by the PVC indicating that the other route segment does not include any other vehicles, may be automatically prevented from moving at speeds above a speed limit when a route segment has a maintenance crew present, etc. This is opposed to ‘negative’ vehicle monitoring systems where a vehicle is allowed to move unless a signal (restricting movement) is received.

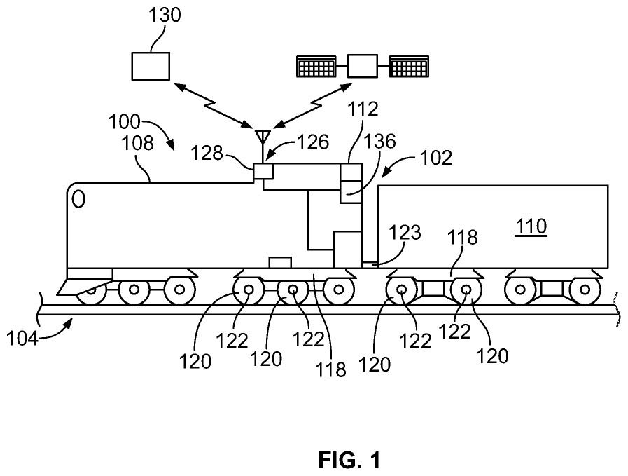

FIG. 1 illustrates a schematic diagram of a monitoring system 100 according to an embodiment. The monitoring system may be disposed on a vehicle system 102. The vehicle system may be configured to travel along a route 104 on a trip from a starting or departure location to a destination or arrival location. The route may be a road (e.g., multi-lane highway or other road), track, rail, air space, waterway, etc. The vehicle system includes a propulsion-generating vehicle 108 and optionally one or more non-propulsion-generating vehicles 110 that are mechanically interconnected to one another to travel together along the route, such as by couplers. For example, the propulsion vehicle can be mechanically coupled to the car by a coupler 123. Alternatively, the vehicles in a vehicle system may not be mechanically coupled with each other, but may be logically coupled with each other. For example, the vehicles may be logically coupled with each other by the vehicles communicating with each other to coordinate the movements of the vehicles with each other so that the vehicles travel together in a convoy or group as the vehicle system.

The propulsion-generating vehicle may be configured to generate tractive efforts to propel (for example, pull or push) the non-propulsion-generating vehicle along the route. The propulsion-generating vehicle includes a propulsion subsystem, including one or more traction motors, that generates tractive effort to propel the vehicle system. The propulsion-generating vehicle may be referred to herein as a propulsion vehicle, and the non-propulsion-generating vehicle may be referred to herein as a car. Although one propulsion vehicle and one car are shown in FIG. 1, the vehicle system may include multiple propulsion vehicles and/or multiple cars. In an alternative embodiment, the vehicle system only includes the propulsion vehicle such that the propulsion vehicle is not coupled to the car or another kind of vehicle. In one example, one of the propulsion vehicles may be a lead vehicle in a multi-vehicle system, where other vehicles are remote vehicles of the multi-vehicle system. In particular, the remote vehicles may be propulsion generating vehicles or non-propulsion generating vehicles.

The monitoring system monitors the location and movements of the vehicle system. The monitoring system may include an imaging device 112 that in an example is a camera. Specifically, the imaging device may be a video camera, infrared camera, high resolution camera, radar, lidar, or the like. The imaging device may be positioned to obtain image data associated with only a route, an operator and the route, the interior of the vehicle system and the route, or the like. In the illustrated embodiment, the monitoring system may be disposed entirely on the propulsion vehicle. In other embodiments, however, one or more components of the monitoring system may be distributed among several vehicles, such as the vehicles that make up the vehicle system. For example, some components may be distributed among two or more propulsion vehicles that are coupled together in a group or consist. In an alternative embodiment, at least some of the components of the monitoring system may be located remotely from the vehicle system, such as at a dispatch location. The remote components of the monitoring system may communicate with the vehicle system (and with components of the monitoring system disposed thereon).

In the illustrated embodiment, the vehicle system may be a rail vehicle system, and the route may be a track formed by one or more rails. The propulsion vehicle may be a locomotive, and the car may be a rail car that carries passengers and/or cargo. Alternatively, the propulsion vehicle may be another type of rail vehicle other than a locomotive. In an alternative embodiment, the vehicle system may be one or more automobiles, marine vessels, aircraft, mining vehicles, agricultural vehicles, or other off-highway vehicles (OHV) system (e.g., a vehicle system that is not legally permitted and/or designed for travel on public roadways), or the like. While some examples provided herein describe the route as being a track, not all embodiments are limited to a rail vehicle traveling on a railroad track. One or more embodiments may be used in connection with non-rail vehicles and routes other than tracks, such as roads, paths, waterways, or the like.

The monitoring system may further include a communication system 126 that includes a lead communication assembly 128 and a remote communication assembly 130. The lead communication assembly may be on-board a lead vehicle, that in one example is a propulsion vehicle. The remote communication assembly may be on a remote vehicle, that can be a propulsion vehicle or non-propulsion vehicle, or at a location remote of the vehicle, such as at a dispatch. The monitoring system may include a line 132 that extends from the lead communication assembly to the remote communication assembly. By providing the line, the lead communication assembly may communicate with the remote communication assembly over-the-wire, based on a distributed power system. The monitoring system may also communicate with the remote communication assembly over-the-air, or wirelessly, based on a radio frequency. Optionally, the configuration information about the vehicle system can be communicated via the wired connection to set up the wireless connection. As an example, road numbers, vehicle location within the vehicle system, or the like, may be shared by the wire connection to assist in the wireless connection being located and activated.

The monitoring system may have a controller 136, or control unit, that may be a hardware and/or software system which operates to perform one or more functions for the vehicle system. The controller receives information from components of the monitoring system such as the imaging device, analyzes the received information, and generates communication signals.

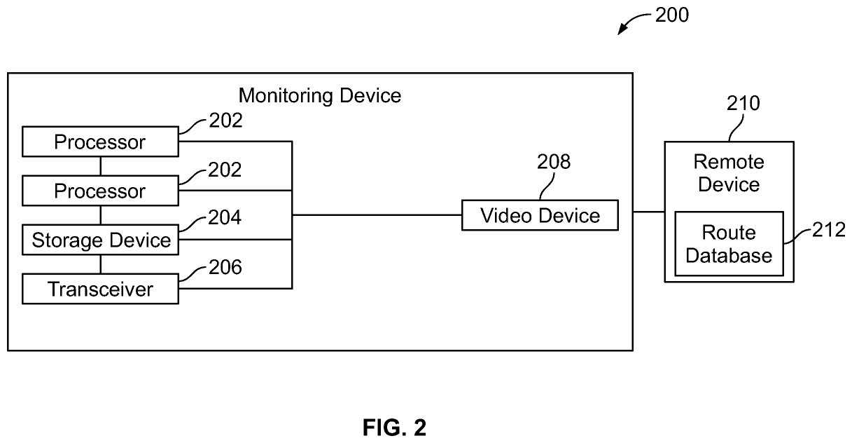

FIG. 2 illustrates a monitoring system 200 that may represent the monitoring system of FIG. 1. The monitoring system may include one or more processors 202, a storage device 204 such as a memory, a transceiver 206, and at least one image device 208. The transceiver may be in communication with a remote device, including other vehicle devices, dispatch devices, PVC systems, etc. The imaging device may be disposed on a controlling locomotive of a rail vehicle system. Alternatively, the image device may be in a lead vehicle of a convoy of vehicles. In another example, the imaging device may be on an end vehicle, including on an end of vehicle device. In other embodiments, a first imaging device may be on a lead vehicle, while a second imaging device is on an end vehicle. Image data from both the first and second imaging device may then be utilized to analyze for location determinations. For example, the image data obtained from the image device onboard a first vehicle in a vehicle system may be analyzed as described herein to determine a first location of the vehicle system and image data obtained from another image device onboard a second vehicle in the same vehicle system may be analyzed as described herein to determine a second location of the vehicle system. The first and second locations can be compared to verify the location of the vehicle system. For example, if these locations are within a defined distance of each other (e.g., the distance between the first and second vehicles in the vehicle system, plus an additional pre-defined margin of error), then the location of the vehicle system may be determined and verified based on the first and/or second locations. But, if these locations are not within the defined distance of each other, then the location of the vehicle system may not be determined and/or a fault with the image device(s) may be identified.

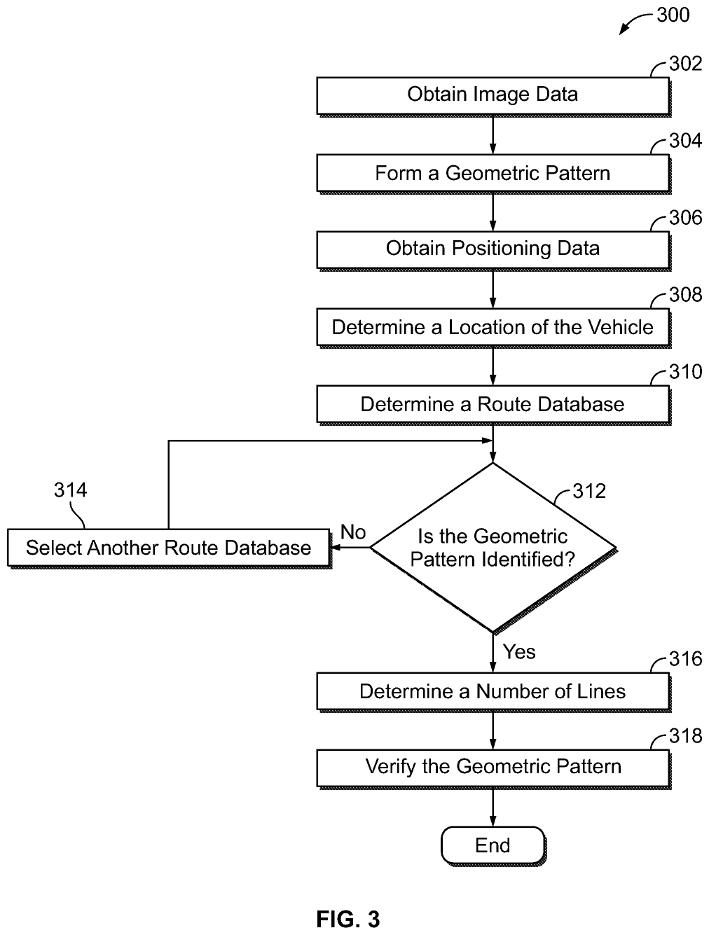

FIG. 3 illustrates a method 300 for selecting the route traversed by a vehicle. In one example, the vehicle is a vehicle and/or vehicle system described in relation to FIG. 1. In another example, a monitoring system is provided that includes a imaging device as described in relation to both FIGS. 1 and 2. In one embodiment, the vehicle and/or vehicle system may be a rail vehicle; however, in other embodiments the vehicle or vehicle system may be an automobile, off road vehicle, aircraft, aquatic vehicle, tractor trailer, truck, or the like. The route may be a rail, road, pathway, waterway, runway, etc.

At 302, image data related to a route is obtained from an imaging device associated with a vehicle. The image data may be obtained from accessing memory of the imaging device, receiving the data, signals, information, etc. over a wireless communications link between the imaging device and a controller of a monitoring system, receiving the data, signals, information, etc. at a server over a network connection, or the like. The obtaining operation, when from the perspective of an imaging device, may include sensing new signals in real time, and/or accessing memory to read stored data, signals, information, etc. from memory within the imaging device or related controller of a monitoring system. The obtaining operation, when from the perspective of a controller of a monitoring device, includes receiving the data, signals, information, etc. at a transceiver of the controller of the monitoring device where the data, signals, information, etc. are communicated from a imaging device.

At 304, a geometric pattern related to the route based on the image data is determined. A geometric pattern may be any set of locations, orientations, sizes, etc. The pattern can be formed from absolute or relative locations, orientations, sizes, combinations, or the like. In particular, the absolute locations, orientations, sizes, combinations may be considered absolute within an image and/or locations of objects relative to each other, including the distance between, angles between, etc. the objects. In one example, a computer-based program, or software, identifies pathways of the route such as tracks, roads, lanes, or the like, and places lines over each, including connecting lines that intersect to determine the geometric pattern. Optionally, environmental landmarks such as switches, geographic landmarks like waterways, mountains, etc. may also have lines placed over each to help determine the geometric pattern. A geometric pattern can include one or more lines.

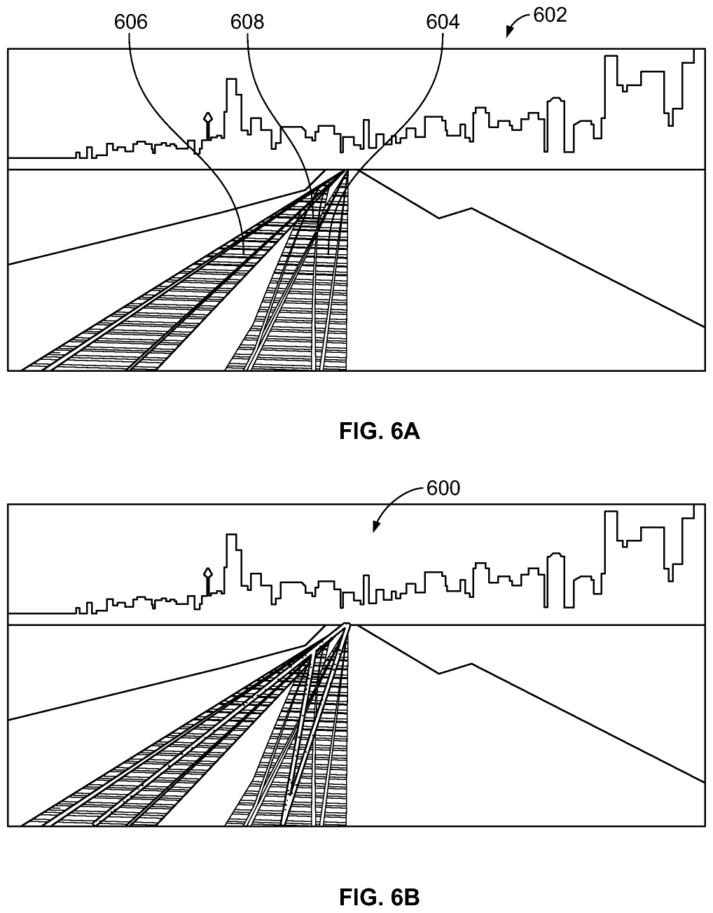

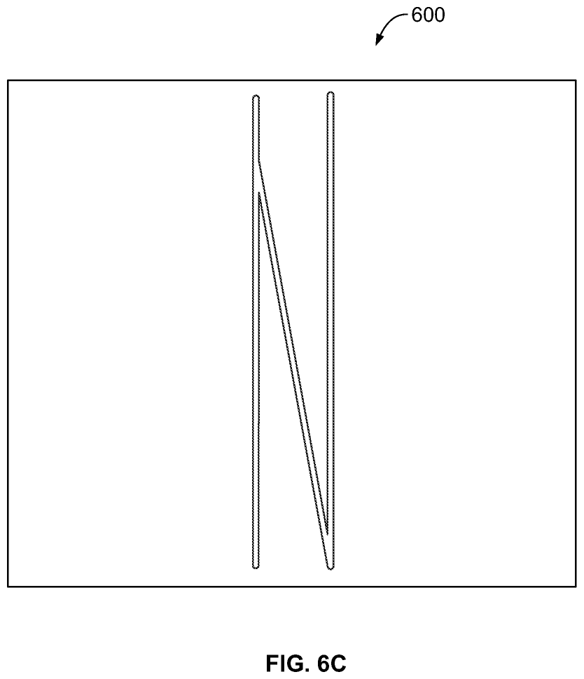

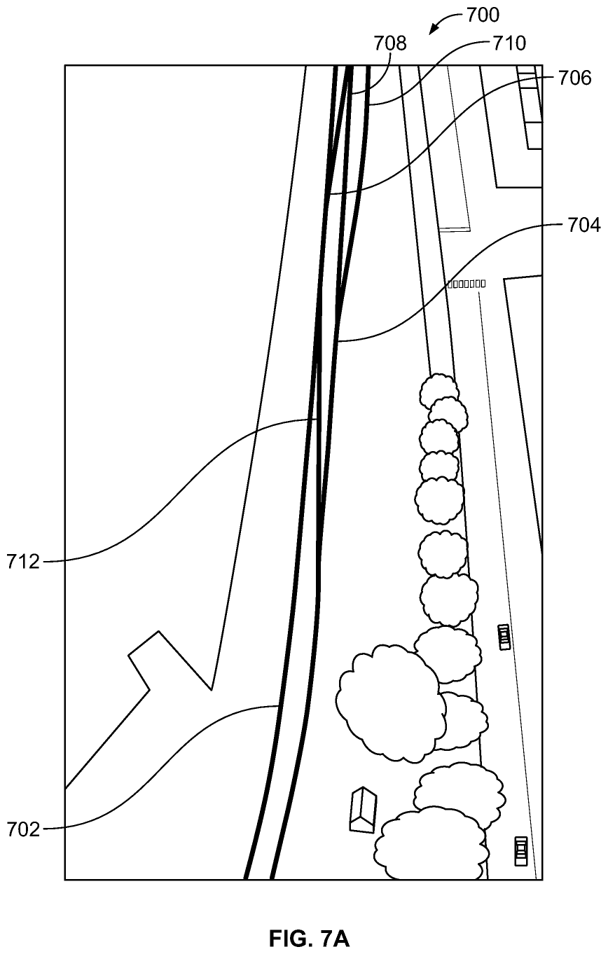

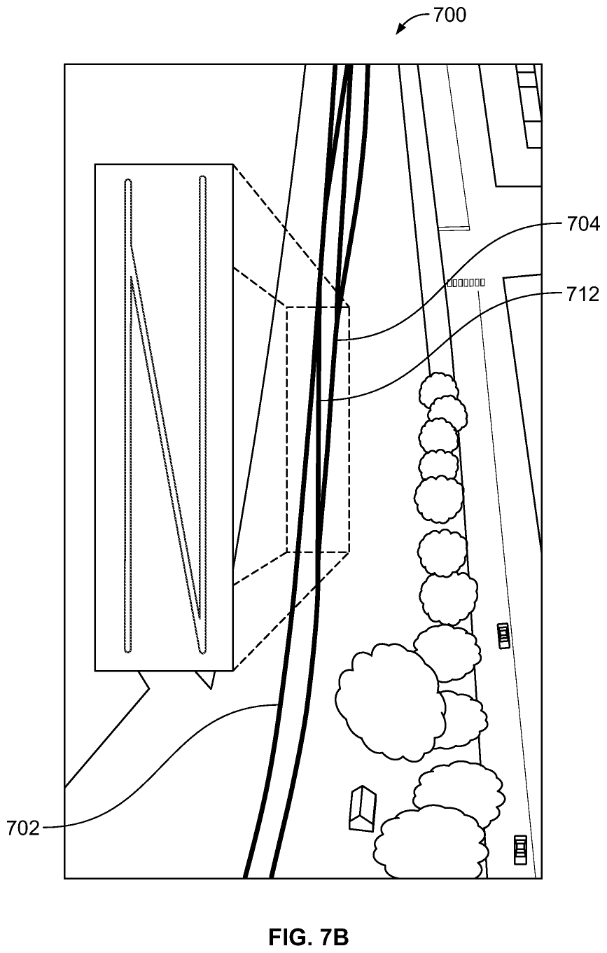

FIGS. 6A-7C illustrate examples of geometric patterns. Patterns may include parallel lines, angled lines, perpendicular lines, V-shapes, T-shapes, Y-shapes, H-shapes, an angled line between two parallel lines, an angled line between two intersecting lines, partial lines that do not intersect, triangles, two or more of any of these listed patterns, etc. In all, the route, or portions of the route, compose the individual lines, and the lines together form the geometric pattern. In one or more examples, the geographic pattern is determined by using the route only, and fills in portions of the route that may not be detected. In particular, over time, brush, foliage, weeds, growth, or the like may cover portions of a route causing a broken line to be detected. In such instances, the system may complete these missing portions of the route to prevent misidentification due to these changes that may occur over time.

In one example, the geometric pattern obtained by a front facing imaging device may be converted into a perspective view that better matches data from a route database. In another example, the view is formed into an overhead view from directly above the route. Alternatively, data from the route database of an overhead view may be converted into a perspective to match the perspective view obtained by the imaging device.

With reference back to FIG. 3, at 306, positioning data is obtained. In one example, the positioning data is obtained from an offboard device. In one example, the offboard device may be a global navigation satellite such as a global positioning system (GPS). The global navigation satellite may be any device that provides positioning data of the system on the earth. This includes by providing positioning data that is, or is related to, longitude and latitude, a place on a map, a position of a vehicle or vehicle system on a road, a position or distance from lane markers, a distance from a monument or other marker, or the like. In particular, the positioning data either provides such information, or may be used to determine such information through calculation, algorithm, look-up table, decision tree, function, etc. The positioning data may be obtained from signals received from satellites, wayside devices, over a wire communication device, over the air communication device, Balise, a beacon, cell tower ID, PVC, etc.

At 308, a location of the vehicle is determined based on the positioning data. Again, the determination may be directly provided by or within the positioning data, or may be derived, calculated, or the like from the obtained positioning data.

At 310, the route database from plural route databases is determined based on the location determined. In particular, plural route databases may be provided. In one example, each state may have an individual route database for rail systems within the state. So, if the determination made is that the vehicle is in Iowa, the Iowa database is determined to be route database. Alternatively, the route database may be regional and include routes across multiple states or jurisdictions. For aircraft, the route database may be an airport database that includes the runway layout of that particular airport. Still, based on the positioning data, one or more processors may determine and communicate with the determined database based on the location determined by the GPS.

At 312, a determination is made whether the geometric pattern is within the selected route database. The route database information may include geographic coordinates, elevation, layout for the route, route name, or the like. If the determined geometric pattern is not within the selected route database, additional positioning data may be obtained, and a new route database may be determined or selected based on the additional positioning data. Alternatively, based on the previously obtained positioning data, at 314 a second route database may be determined and selected. In such an instance, one or more processors may use an algorithm, mathematical function, look up table, decision tree, etc. to determine a second route database that is different than the first route database. In one example, a multi-vehicle system may be crossing a border, resulting in the positioning data to indicate the vehicle system is in a first jurisdiction, while the image data obtained is within a second jurisdiction. So, the route database of the first jurisdiction may not be within the first selected route database. The one or more processors may determine that a second route database is also in close proximity to the vehicle, where that second route database is from the second jurisdiction, and the correct database.

Alternatively, if the geometric pattern determined is within the selected route database, optionally, at 316, a number of lines on a first side of the route and/or second side of the route are determined. In one example, the geometric pattern of parallel lines with an angled intersecting line may be determined and matched in the route database. Still, additional lines may be presented. In an effort to verify the correct location, the lines on either side of the matching shape may also be determined.

At 318, a determination is made whether the geometric pattern identified is verified based on the number of geometric features on the first side of the route. In one example, the geometric features may include geometric features, angles, two-dimensional shapes, three dimensional shapes, etc. In particular, by reviewing the number of geometric features on a side of a route, an extra method of determining the location of the vehicle system is provided, such that if both determinations match, verification of the route is provided. Such verification can be utilized to provide additional confidence to a vehicle operator or monitor that the route has been correctly determined. If the number of geometric features does not match, or verify the geometric pattern identified, then at 320 an alert signal is communicated. The alert signal may include an auditory sound, flashing, or the like to bring attention to the alert signal. The alert signal may indicate the route determined, the name of the route determined, the position of the route determined, etc. along with an indication that the route determined has not been verified. By indicating verification has not occurred, such information may be logged for analysis at a later time.

The indication that the route determined has not been verified may state “unverified”, provide a probability of likelihood the route is accurate, provide visual side-by-side evidence of the matched routes, provide an overlay of the matching routes, etc. Specifically, in some instances, all of the geometric features formed by individual routes may not end up in the image data obtained by the imaging device. Similarly, more individual routes may not end up in the images within the database. The imaging device, angle of imaging device, positioning of imaging device, type of imaging device, range of imaging device, field of vision of the imaging device, etc. of the imaging device that obtains the image data may differ from the imaging device that obtains the image data recorded in the route database. Alternatively, foliage, environmental growth, or the like may cause changes in the route and surround area that is being captured in an image. In one example, the route database may be updated to eliminate image data more than a determined period, such as a year, old. In this manner, the effects of environmental growth or changes on matching images may be reduced.

In all, a partial match of geometric patterns may result in correctly identifying the location of the vehicle, even though all geometric features do not match. Thus, providing additional information to the individual determining the location of the vehicle based on the image data allows the individual to decide if an unverified determination is in fact still the correct determination.

In another example, the one or more processors have image fitting software to fit the image data obtained from the imaging device of the vehicle to that image data within a database. Specifically, the size and shape of the resulting image from the image data is adjusted to provide the size and shape of the image within the database, so that an exact match may be provided.

In other embodiments, an artificial intelligence algorithm may be utilized where weights are given to different variables in an image such as pixels, colors, objects, or the like. Based on weighted variables, a determination is made. Specifically, a first weight may be given to pixel count, a second weight may be given to image colors, and a third weight give to sizes of objects. The artificial intelligence algorithm may provide initial weights to each variable, either by the weights being assigned by an individual, or defaulted by the algorithm. Then, when a determination is made regarding the location, an input is provided to allow the algorithm to have information regarding whether the determination was correct. If the algorithm is correct, a reward is provided for the variables accordingly. When the algorithm provides an incorrect result, the variables are also adjusted. Then, when the next iteration of a determination is made with the algorithm, the variables are updated, and the process is repeated. In this manner, the artificial intelligence algorithm may vary its variables to provide more accurate determinations.

If at 318, the geometric pattern is verified, then the method can terminate.

In all, the position of the vehicle is identified first using the position data in a coarse location detection process, and then using the geometric pattern matching in a fine location detection process. This fine location detection process provides more accurate results than the mere course location process. In this manner, the position data is only used to determine the general vicinity of the vehicle, while the matching of geometric shapes provides the exact location. Additionally, the counting of geometric features is only used to help verify the results of the matching of the geometric shapes, and not relied upon to determine the location of the vehicle. In this manner, when the imaging devices obtaining the image data differ, the difference may be accounted for by using the geometric patterns instead of merely counting geometric features. Thus, an improved method of determining location of the vehicle is provided.

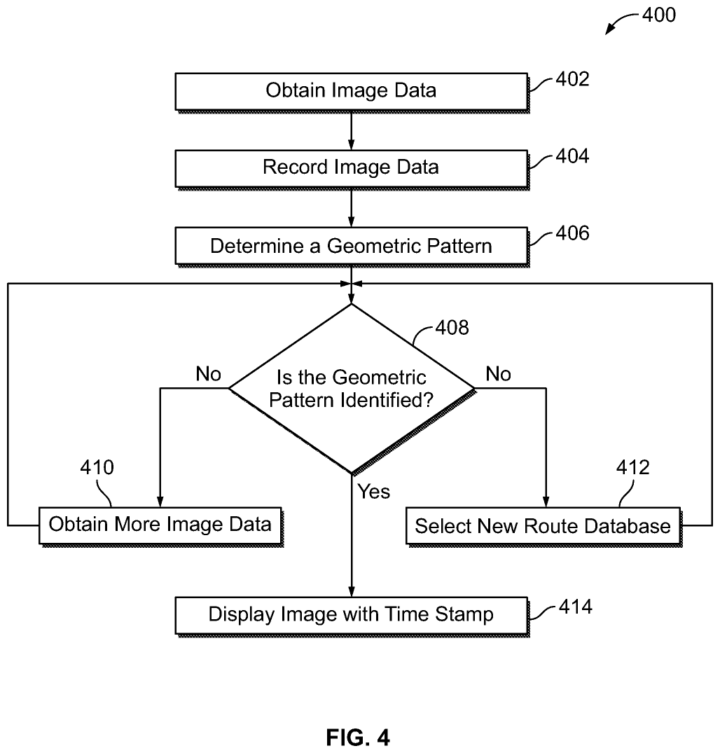

FIG. 4 illustrates a method 400 of displaying a route location of a vehicle. In one example, the vehicle is a vehicle and/or vehicle system described in relation to FIG. 1. In another example, a monitoring system is provided that includes a imaging device as described in relation to both FIGS. 1 and 2. In one example, the method is provided in addition to the method of FIG. 3, while alternatively, the method is provided as part of an incorporated into the method of FIG. 3.

At 402, image data related to a route is obtained from an imaging device associated with a vehicle. The image data may be obtained using any of the methodologies as described or discussed in relation to FIG. 3.

At 404, the time the image data is received or communicated is recorded. In one example, the storage device is the storage device of the imaging device. Alternatively, the storage device is the storage device of a controller of a monitoring system. By recording the time the image data is received or communicated, if detection or verification of vehicle location is taking place over an extended interval, such as more than five seconds but less than two minutes, the exact location of the vehicle at the time of determination or verification can be determined. Specifically, by knowing the location of a vehicle at a specific time, along with route shape (straight, curved, etc.) and estimated or measured speed of the vehicle, the exact location of the vehicle may be determined, calculated, or estimated even with a delay of matching geometric patterns or verifying a match determination.

At 406, a geometric pattern related to the route is determined based on the image data. The determination may be made using any of the methods described or discussed in relation to FIG. 3

At 408, a determination is made whether the geometric pattern determined is within a route database, to determine the route of the vehicle. Specifically, the determination may be made using any of the methods described or discussed in relation to FIG. 3. The geometric pattern may be of route images that show the route itself as a geometric pattern. For example, tracks, a road, runway, or the like may form the geometric pattern. Alternatively, a geographic landmark, such as a mountain in the background, a grassy field, or the like may form the geometric pattern. In another example, both geometric patterns in the geographic location and route are utilized. If no match is determined, more data may be taken, and another determination with more data may be provided. Alternatively, a different route database may be searched at 410 as described in relation to FIG. 3.

If the geometric pattern determined is within a route database, at 412, the geometric pattern determined is displayed on an image on a display with the time the image data was received. Specifically, the real-time image data received may be displayed on a screen to provide information to an individual regarding when the vehicle was at the position recorded.

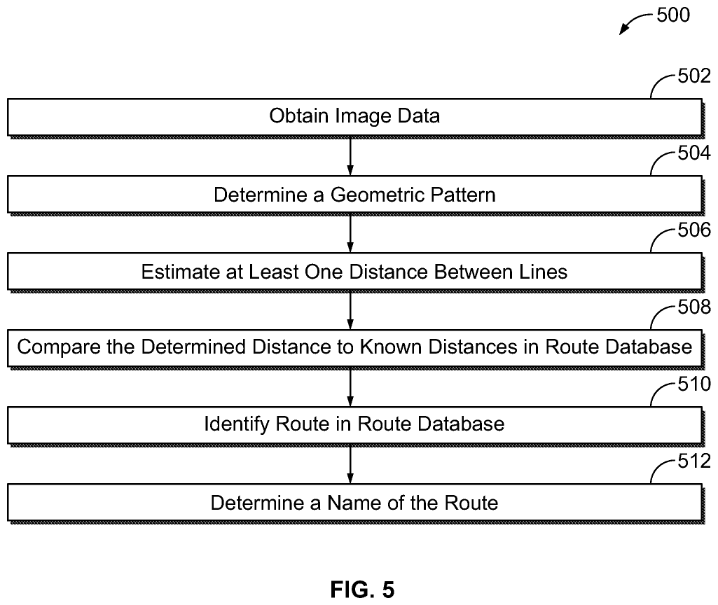

FIG. 5 illustrates a method 500 of determining the location of a vehicle. In one example, the vehicle is a vehicle and/or vehicle system described in relation to FIG. 1. In another example, a monitoring system is provided that includes an imaging device as described in relation to both FIGS. 1 and 2.

At 502, image data related to a route is obtained from an imaging device associated with a vehicle. The image data may be obtained using any of the methodologies as described or discussed in relation to FIG. 3.

At 504, a geometric pattern related to the route is determined based on the image data. The determination may be made using any of the methods described or discussed in relation to FIG. 3

At 506, at least one distance between lines in the geometric pattern determined is estimated. In one example, the route is parallel running tracks where a known distance is located between the two sets of tracks. The distance between tracks may be unique, or may narrow a search. In particular, many sets of parallel tracks may exist in images within a database; however, by measuring the distance between parallel tracks, an additional variable is provided that may eliminate and/or reduce the number of potential track locations. In one example, the distance between tracks may be measured using imaging software for estimating distances between objects based image characteristics. In one example, the pixel count of object may be used to determine the real-world distance between a first set of tracks and a second set of tracks.

At 508, the at least one distance between lines in the geometric pattern determined is compared to a distance between lines in the route images to determine the route of the vehicle. Specifically, images of routes may be with a route database, with the actual distance between lines in the route database images known, or calculated using similar software described above. In this manner, the distance between the lines is known, and can be used to compare to the estimate. As a result, all routes with line distances that do not fall within a threshold of the actual, or route database distance may be eliminated from consideration as the location of the vehicle. Thus, an additional way of identifying, and selecting the route location is realized.

At 510, the at least one distance between the line in the geometric pattern in the route data of route images is identified to determine the route of the vehicle. In one example, the comparison of the line distances is solely used as the manner of identifying the route, without comparing the geometric patterns. Because some distances between lines in the route in a given region are unique, if only one match is provided, the location may be identified only from the distance between the lines in the image.

At 512, a name of the route is determined based on the geometric pattern determined, or at least one distance between lines in the geometric pattern. Specifically, in some embodiments, the name of a route may be known, such as a street name, rail line, runway name, or the like. Based on the location determined, regardless of the methodology (e.g. including the methodologies of FIGS. 3-5), the name of the route may be determined and communicated. The communication may be to an operator, dispatch, remote device, or the like. Thus, if a vehicle switches pathways, streets, rail lines, etc. the communication instantly provides the change. When used in association with a PVC, errors are reduced, and safety increased.

FIGS. 6A-6C illustrates how an example geometric pattern 600 may be used to determine or identify the location of a vehicle on a route. In the example, tracks of a route of a rail vehicle are provided as lines that form the geometric pattern. Additionally, the figure illustrates a converted image 602, where one or more processors have obtained an image of the route and converted the image of the route into a geometric pattern. To this end, each line in the example represents a track of the route. In other examples, the lines may represent roads, runways, water markers, pathways, etc.

In the converted image, a first track 604, second track 606, and third track 608 are illustrated with a first switching track 610 between the first track and second track, and a second switching track 612 between the second track and third track. In particular, the third track splits from the second track, and the first switching track and second switching track allow different vehicles access to all three tracks. As illustrated, a very unique geometric pattern is formed that can be identified.

As illustrated in FIG. 6B, by using the methodology of at least one of FIGS. 3-5, a geometric pattern of an N-like shape may be identified to determine the location of the vehicle. FIG. 6C illustrates the N-like shape reduced down by the one or more processors to be compared to other track geometries within a route, or track, database. Advantageously, the distances between the first and second tracks and the switching track may be determined, along with the shape providing the exact angle of between the tracks. Thus, compared to a counting method where a vehicle on a first track would identify two tracks on the left, by using a geometric pattern, significantly more detail regarding the route is provided. This detail may be used to accurately identify this section of track compared to all the other sections of track in a region having two tracks to the left of a first track.

Additionally, depending on the decisions of the operator, the continued obtaining of image data may be used to determine the track chosen by the operator at the location. Specifically, when only using global navigation satellite position data or counting, determining the specific track chosen may be difficult, resulting in delayed, and potentially inaccurate information being communicated to a remote controller such as a PVC. By using the image data, the PVC receives more accurate information faster, allowing better determinations for other vehicles traveling the route.

FIGS. 7A and 7B illustrate another example of how the methodologies discussed herein may be used to identify a location of a vehicle. FIG. 7A illustrates the geometric pattern 700 of a complex route that includes a first route 702, second route 704, third route 706, fourth route 708, and fifth route 710, where a switching route 712 is provided between the first route and second route. FIG. 7B illustrates a converted image based on the capabilities of an imaging device. In particular, because of real-world considerations, only the first, second, and third route, along with the switching route are captured by the imaging device. Specifically, the imaging device is unable to capture the fourth and fifth routes as too wide, or not within the field of view of the imaging device. In this instance, if a counting method were being utilized for a vehicle on the first route, only three routes to the right would be identified instead of five. This would lead to inaccuracies in identifying the location of the vehicle. By using the geometric pattern instead, the routes are matched more quickly, expediently, and accurately. Again, when a PVC is utilized, the accuracy and speed of the information received by the PVC system vastly improves analysis of the PVC.

In one or more embodiments, a method is provided that may include obtaining image data related to a route from a imaging device associated with a vehicle, determining a geometric pattern related to the route based on the image data, and identifying the geometric pattern determined within a route database to determine the route of the vehicle.

Optionally, the method may also include obtaining positioning data from an offboard device; determining a location of the vehicle based on the positioning data, and selecting the route database from plural route databases based on the location determined. In another aspect, the method may include determining a number of geometric features on a first side of the route, and verifying the geometric pattern identified based on the number of geometric features on the first side of the route. In one example, the method may further include displaying the geometric pattern determined on an image on a display. In another aspect, the method may also include recording a time the image data is received, and displaying the time the image data is received on the image.

Optionally, the method may also include estimating at least one distance between geometric features in the geometric pattern determined. In another aspect, the method may also include comparing the at least one distance between geometric features in the geometric pattern determined to a distance between lines in a route image of the route database to determine the route of the vehicle. In another aspect, the method also includes determining a name of the route based on the geometric pattern determined.

In one or more embodiments, a system is provided that may include a monitoring system including at least one imaging device that is configured to be disposed within a vehicle and positioned to capture image data related to a route of the vehicle. The system may also include one or more processors that are configured to obtain the image data related to the route from the at least one imaging device, determine a geometric pattern related to the route based on the image data, and identify the geometric pattern determined within a route database to determine the route of the vehicle.

Optionally, the one or more processors may further be configured to obtain positioning data from an offboard device, determine a location of the vehicle based on the positioning data, and determine the route database from plural route databases based on the location determined. In another aspect, the one or more processors may further be configured to determine a number of geometric features on a first side of the route responsive to identifying the geometric pattern determined within the route database, determine a number of geometric features of a second side of the route responsive to identifying the geometric pattern determined within the route, and verify the geometric pattern identified based on the number of geometric features on the first side of the route and the number of geometric features on the second side of the route. In one example, the system also includes a display in communication with the one or more processors, and the one or more processors may further be configured to display the geometric pattern determined on an image on the display.

Optionally, the one or more processors may further be configured to record a time the image data is received, and display the time the image data is received on the image on the display with the geometric pattern. In one aspect, the one or more processors may further be configured to estimate at least one distance between lines in the geometric pattern determined, compare the at least one distance between lines in the geometric pattern determined to a distance between lines in route images within the route database, and determine the route of the vehicle based at least in part on comparison of the at least one distance between lines in the geometric pattern and the distance between lines in the route images. In another aspect, the one or more processors may further be configured to determine a name of the route based on the geometric pattern determined.

In one or more embodiments, a system is provided that may include a monitoring system with at least one imaging device that is configured to be disposed within a vehicle and positioned to capture image data related to a route of the vehicle. The system also may include one or more processors configured to obtain the image data related to the route from the at least one imaging device, and determine a geometric pattern related to the route based on the image data. The one or more processors may also be configured to obtain positioning data from a offboard device, select a route database based on the positioning data, and match the geometric pattern determined to a geometric pattern of a route image within the route database selected to determine the route of the vehicle.

Optionally, the one or more processors may further be configured to determine a number of geometric features on a first side of the route when determining the geometric pattern, compare the number of geometric features on the first side of the route to a number of geometric features in the route image within the route database, and verify the route determined based on the number of geometric features on the first side of the route. In another aspect, the system may also include a display in communication with the one or more processors, and the one or more processors may also be configured to overlay the geometric pattern determined with the route image on the display. In an example, the one or more processors may also be configured to estimate at least one distance between lines in the geometric pattern determined, compare the at least one distance between lines in the geometric pattern determined to a distance between lines in the route image, and determine the route of the vehicle based at least in part on comparison of the at least one distance between lines in the geometric pattern and the distance between lines in the route images. In one aspect, the one or more processors may also be configured to determine a name of the route based on the geometric pattern determined.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device, and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
obtaining image data from an image device onboard a vehicle;
determining a geometric pattern from the image data; and
identifying a location of the vehicle on a route based on the geometric pattern that is determined from the image data.

2. The method of claim 1, further comprising:
obtaining positioning data from an off-board system;
determining a location of the vehicle based on the positioning data; and
selecting the route database from plural route databases based on the location determined.

3. The method of claim 1, further comprising:
determining a number of geometric features on a first side of the route; and
verifying the geometric pattern identified based on the number of geometric features on the first side of the route.

4. The method of claim 1, further comprising:
determining a distance between geometric features in the geometric pattern that is determined;
comparing the distance in the geometric pattern to a distance between geometric features in a route image of the route database to determine the route of the vehicle.

5. The method of claim 4, wherein the geometric pattern includes at least one line.

6. The method of claim 1, wherein the identity of the route is determined and used by a monitoring system on-board the vehicle to control movement of the vehicle.

7. The method of claim 1, wherein the route is a multi-lane highway or road and the identity of the route that is determined is a lane in the multi-lane highway or the road on which the vehicle is located.

8. The method of claim 1, wherein the geometric pattern is at least one of parallel lines, angled lines, perpendicular lines, a V-shape, a T-shape, a Y-shape, a H-shape, an angled line between two parallel lines, an angled line between two intersecting lines, partial lines that do not intersect, or a triangle.

9. A system comprising:
a monitoring system including at least one imaging device that is configured to be disposed within a vehicle and positioned to capture image data related to a route of the vehicle;
one or more processors configured to:
obtain the image data related to the route from the at least one imaging device;
determine a geometric pattern related to the route based on the image data; and
identify the geometric pattern determined within a route database to determine the route of the vehicle.

10. The system of claim 9, wherein the one or more processors are further configured to:
obtain positioning data from a offboard device;
determine a location of the vehicle based on the positioning data; and
determine the route database from plural route databases based on the location determined.

11. The system of claim 9, wherein the one or more processors are further configured to:
determine a number of geometric features on a first side of the route responsive to identifying the geometric pattern determined within the route database;
determine a number of geometric features of a second side of the route responsive to identifying the geometric pattern determined within the route; and
verify the geometric pattern identified based on the number of geometric features on the first side of the route and the number of geometric features on the second side of the route.

12. The system of claim 9, wherein the one or more processors are further configured to:
estimate at least one distance between lines in the geometric pattern determined;
compare the at least one distance between lines in the geometric pattern determined to a distance between lines in route images within the route database; and
determine the route of the vehicle based at least in part on comparison of the at least one distance between lines in the geometric pattern and the distance between lines in the route images.

13. The system of claim 9, wherein the identity of the route is determined and used by a monitoring system on-board the vehicle to control movement of the vehicle.

14. The system of claim 9, wherein the route is a multi-lane highway or road and the identity of the route that is determined is a lane in the multi-lane highway or the road on which the vehicle is located.

15. The system of claim 9, wherein the one or more processors are further configured to: determine a name of the route based on the geometric pattern determined.

16. A system comprising:
a monitoring system including at least one imaging device that is configured to be disposed within a vehicle and positioned to capture image data related to a route of the vehicle;
one or more processors configured to:
obtain the image data related to the route from the at least one imaging device;
determine a geometric pattern related to the route based on the image data;
obtain positioning data from a offboard device;
select a route database based on the positioning data; and
match the geometric pattern determined to a geometric pattern of a route image within the route database selected to determine the route of the vehicle.

17. The system of claim 16, wherein the one or more processors are further configured to:
determine a number of geometric features on a first side of the route when determining the geometric pattern;
compare the number of geometric features on the first side of the route to a number of geometric features in the route image within the route database; and
verify the route determined based on the number of geometric features on the first side of the route.

18. The system of claim 16, wherein the one or more processors is further configured to identify the geometric pattern determined within a route database to determine an identity of the route;
wherein the route is a multi-lane highway or road and the identity of the route that is determined is a lane in the multi-lane highway or the road on which the vehicle is located.

19. The system of claim 16, wherein the one or more processors are further configured to:
estimate at least one distance between lines in the geometric pattern determined;
compare the at least one distance between lines in the geometric pattern determined to a distance between lines in the route image; and
determine the route of the vehicle based at least in part on comparison of the at least one distance between lines in the geometric pattern and the distance between lines in the route images.

20. The system of claim 16, wherein the one or more processors are further configured to: determine a name of the route based on the geometric pattern determined.
